(19) United States
(12) Patent Application Publication
(10) Pub. No.: US 2009/0282955 A1
(43) Pub. Date: Nov. 19, 2009

(54) Driver Bit for Easy Attachment and Detachment with Driver Tool

(76) Inventor: Chiu-Man Chang-Kao, Wuri Shiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/120,277

(22) Filed: May 14, 2008

(51) Int. Cl. B25B 23/00

(52) U.S. Cl. 81/438; 81/460

(57) ABSTRACT

A driver bit comprises has a body including a bit shank formed on an end thereof and a driving end formed on another end thereof opposite to the bit shank. The driving end is adapted for operation with a fastener. A bit flange is combined with the body between the bit shank and the driving end. Two holder portions are formed on the outer periphery of the bit flange for a user's thumb and forefinger to grip thereon, with the two holder portions being opposite to each other.

### BACKGROUND OF THE INVENTION

1. Field of the Invention

The present invention relates to a driver bit which allows an easy operation of attachment and detachment with a driver tool.

2. Description of the Related Art

A driver tool is adapted for connecting with several sizes or standards of driver bits, and hence the driver tool can connect with several sizes or standards of fasteners. It can efficiently reduce load of users to carry tool kit therewith outgoings.

Referring to FIG. 12, a conventional screwdriver bit 91 adapted for being connected with a screwdriver handle 92. The screwdriver bit 91 includes a projection 911 formed on an end thereof and a fastener-driving portion 912 opposite to the projection 911. The projection 911 is in form of a standard hexagon and made of metal so that the projection 911 can be attracted by a magnetic material. The screwdriver handle 92 includes a handle portion 921 for users to hold and a sleeve portion 922 formed on an end of the handle portion 921 and having a magnetic material therein so that the sleeve portion 922 can magnetically receive the projection 911 of the screwdriver bit 91 therein. While the projection 911 is connected with the sleeve portion 922 via the magnetic material, however, a shortcoming of this magnetic connection is difficult to detach the projection 911 from the sleeve portion 922 after operation of the screwdriver bit 91. Because there's no holding region on the screwdriver bit 91 for users to hold to pull the screwdriver bit 91 out from the sleeve portion 922 of the screwdriver handle 92. Users can only hold on the fastener-driving portion 912 for pulling the screwdriver bit 91 outwardly and it is hard to force on the screwdriver bit 91. Further, when several sizes of screwdriver bits are received in a bit container (not shown), users can not immediately find a suitable bit for use.

Additionally, referring US Pat Application No 2008/0072718, a screw bit positioning device includes a tube which has a first hole and a second hole respectively defined through a wall thereof so that a first bead and a second bead are respectively engaged the first and second holes. A movable member is movably received in a passage and located between a stop and a first spring. A sleeve is movably mounted to the tube and cooperates with a second spring mounted on the tube such that when the sleeve is moved, the first and second beads are simultaneously pressed into the tube or received in two respective spaces in the inner periphery of the sleeve. The screw bit and the movable member are positioned when the first and second beads are merged into the tube. When the first and second beads are released, the screw bit is pushed out from the tube by the first spring. It is a firmly connection between the screw bit and the tube, however, the structure of the tube is excessively complicated, and further this structure of the tube cannot be directly replaced with a connective end of a handle of a conventional driver tool for connecting with a screw bit.

The present invention is therefore intended to obviate or at least alleviate the problems encountered in prior art.

### SUMMARY OF THE INVENTION

It is therefore an object of the present invention to provide a driver bit that is adapted for easy attachment and detachment form a driver handle without additional joint.

Accordingly, the present invention provides a driver bit for a driver tool, the driver bit includes a body and a bit flange combined with the outer periphery of the body. An end of the body forms a body shank, and a driving end is defined on another end of the body. The bit flange is disposed between the body shank and the driving end and includes two holder portions on the outer periphery thereof for user to grip easily.

An advantage to the present invention is that each of the holder portions has flat surface for user's thumb and forefinger to grip thereon.

Another advantage to the present invention is that the bit flange can be colored with various colors for indicating the type or size of the driving end of driver bit.

Other objectives, advantages, and features of the invention will become more apparent from the following detailed description when taken in conjunction with the accompanying drawings.

### BRIEF DESCRIPTION OF THE DRAWINGS

The present invention will be described via detailed illustration of the preferred embodiment referring to the drawings.

FIG. 1 is a perspective view of a driver bit according to the first embodiment of the present invention.

FIG. 2 is an exploded view of the driver bit shown in FIG. 1.

FIG. 3 is a cross-sectional view taken along 3-3 in FIG. 1, illustrating the bit flange combined with the body.

FIG. 4 is a cross-sectional view taken along 4-4 in FIG. 1, illustrating a top view of the bit flange.

FIG. 5 is cross-sectional view taken along 5-5 in FIG. 3.

FIG. 6 is a perspective view of the driver bit, which is held by a user and connects with a driver handle according to the first embodiment of the present invention.

FIG. 7 is a side view of the connection of the driver bit and the driver handle shown in FIG. 6.

FIG. 8 is a perspective view of the driver bit and a connective rod according to the second embodiment of the present invention.

FIG. 9 is a perspective view of a driver bit according to the third embodiment of the present invention.

FIG. 10 is a perspective view of a driver bit according to the fourth embodiment of the present invention.

FIG. 11 is a perspective view of a driver bit according to the fifth embodiment of the present invention.

FIG. 12 is a perspective view of a conventional screwdriver bit and a screwdriver handle.

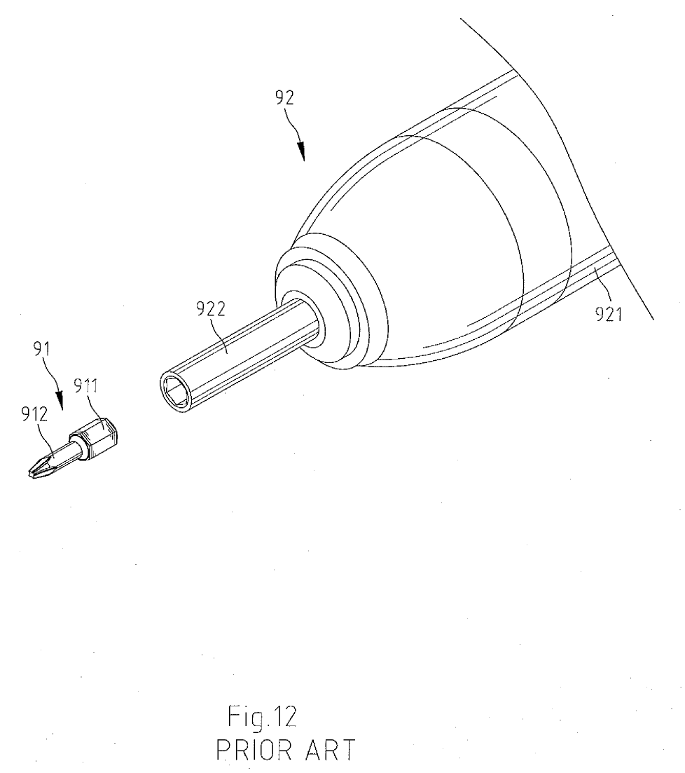

### DETAILED DESCRIPTION OF THE PREFERRED EMBODIMENT

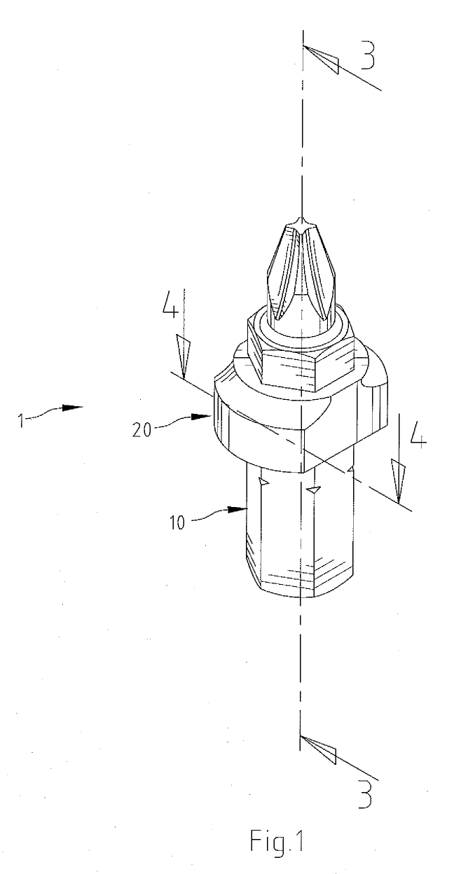

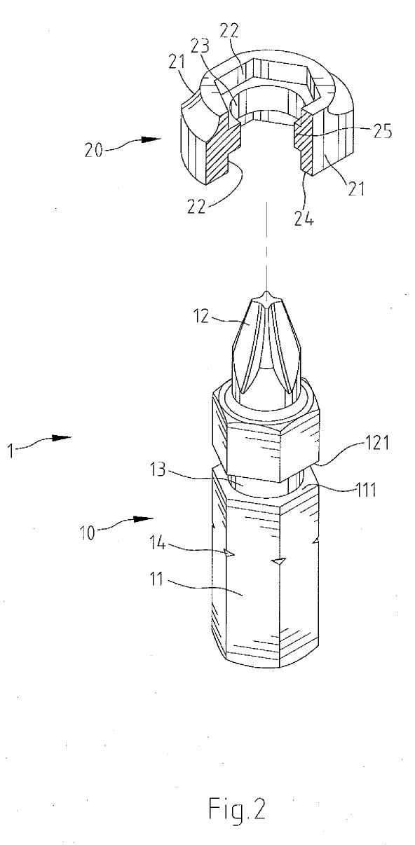

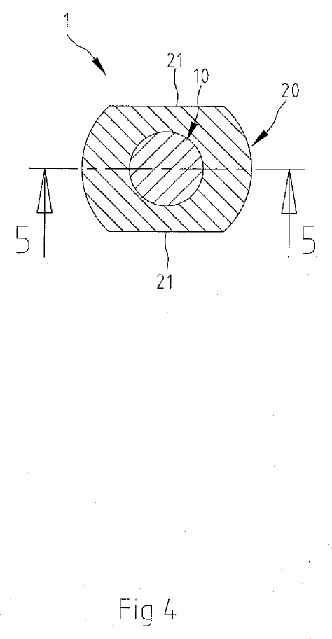

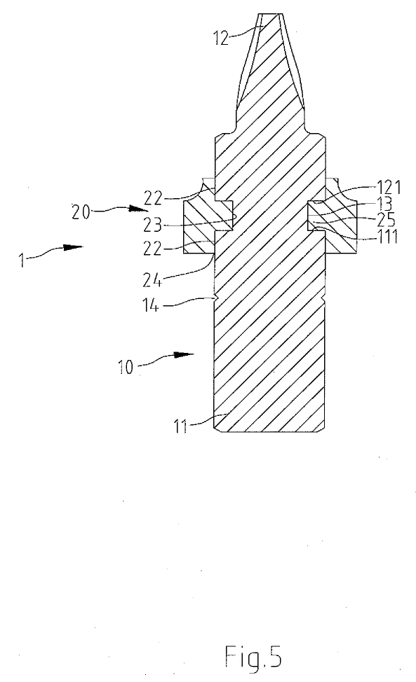

Referring to FIGS. 1 through 7, a driver bit 1 and a driver handle 2 in accordance with a first embodiment in the present invention, the driver bit 1 is adapted for connecting with the driver handle 2 as described in more detail below and includes a body 10 and a bit flange 20 adapted to be combined with the body 10. The body 10 is preferably made of metal which is attracted by a magnetic material. A bit shank 11 is formed on a first end of the body 10 and a driving end 12 is formed on a second end of the body 10 opposite to the bit shank 11. The bit shank 11 is in form of a standard hexagon and has six sidewalls. A groove 13 is formed around in position of the bit shank 11. A hexagonal first abutting end 111 and a hexagonal second abutting end 121 are respectively defined on the bit shank 11 and the driving end 12, with the groove 13 between the first and second abutting ends 111 and 121. A plurality of notches 14 is provided on the bit shank 11 adjacent to the groove 13, with each of the notches 14 on a seam line defined between each two of sidewalls of the bit shank 11. The notches 14 are designed for attachment and detachment of the driver bit 1 from the driver handle 2 via a quick release device (not shown) alternatively. The driving end 12 is preferably in form of a slotted head or a crosshead screwdriver or a hex key or a square drive screwdriver or a torx head screw or a triple square screw or a Tri-Wing screwdriver with several sizes.

The bit flange 20 is mounted on the body 10 via positioning in the groove 13. Two holder portions 21 are respectively defined on the outer periphery of the bit flange 20 and opposite to each other. Each of the holder portions 21 is preferably in form of a flat surface for an easy handhold of users' thumb and forefinger. A through-hole 23 is defined in the bit flange 20. Two hexagonal first limited portions 22 and a circular second limited portion 25 are respectively delimited in the inner periphery of the bit flange 20 around the through-hole 23. The second limited portion 25 is between the first limited portions 22 and protrudes form the inner wall of the through-hole 23. A blocking end 24 is formed on an end of the bit flange 20 toward the body 10. The first limited portions 22 respectively communicate with the through-hole 23 and open to the two ends of the bit flange 20. The second limited portion 25 exactly corresponds to the groove 13, and the first limited portions 22 respectively correspond to the first and second abutting ends 111 and 121. The bit flange 20 is preferably made of plastic and inject-molded via pre-buried with the body 10 or integrally formed with the body 10 as one piece. The holder portions 21 are provided for a handhold of users and further preventing the driver bit 1 rolling on the ground. While the driver bit 1 falls on the ground, although the shape thereof is hexagonal, it might occur a roll of the driver bit 1 because of the small volume of the driver bit 1. So that it can avoid loss of the driver bit 1.

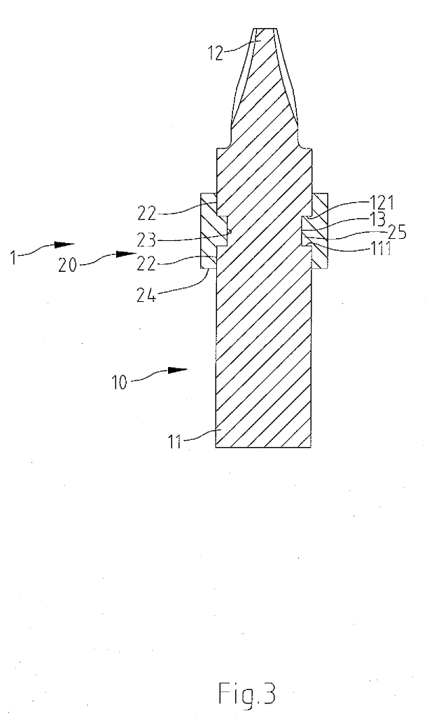

Referring to FIGS. 3 through 5, the bit flange 20 has been combined with the body 10; meanwhile the hexagonal first limited portions 22 are tightly mounted on the hexagonal first and second abutting ends 111 and 121, respectively, and the circular second limited portion 25 is tightly received in the groove 13. So that the bit flange 20 will not rotate relative to the body 10 and it can prevent the bit flange 20 detaching form the body 10.

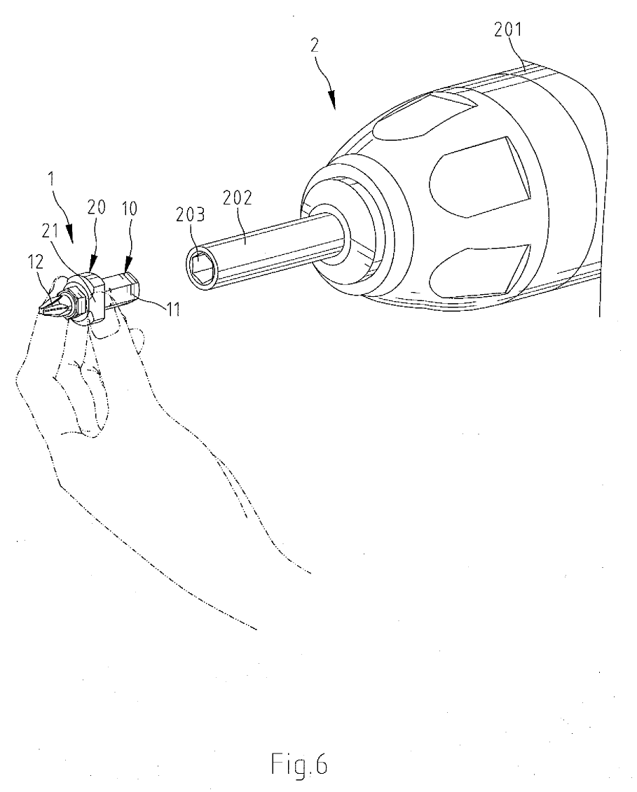

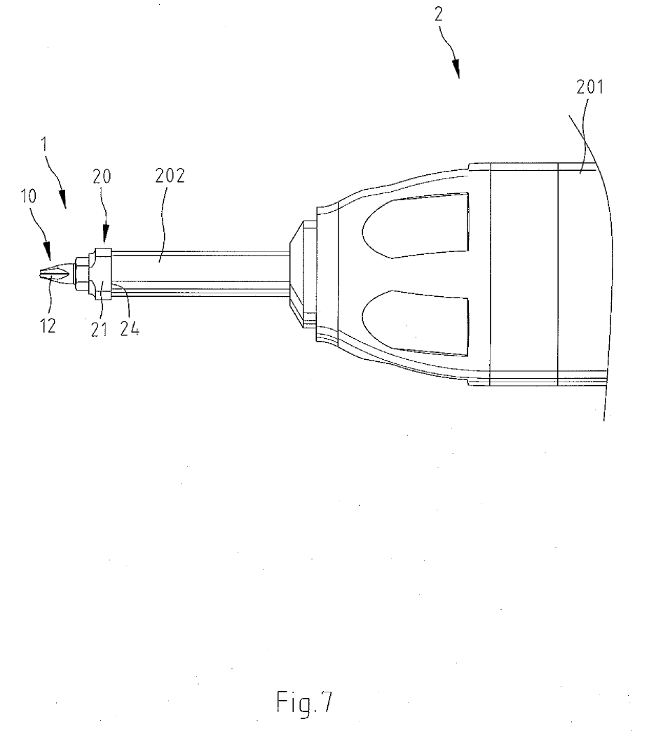

Referring to FIGS. 6 and 7, the driver handle 2 includes a handle portion 201, a sleeve portion 202 extending from the front end of the handle portion 201 and a connected portion 203 defined on an end of the sleeve portion 202 for receiving the bit shank 11 of the driver bit 1. The connected portion 203 preferably has a magnetic material therein for connecting with the driver bit 1 magnetically. A user's thumb and forefinger (not numbered) can grip the holder portion 21 of the bit flange 20 of the driver bit 1 to put the bit shank 11 of the driver bit 1 into the connected portion 203 of the driver handle 2. Accordingly, the driver bit 1 will not detach form the driver handle 2 freely because of the magnetic material of the connected portion 203. Simultaneously, the blocking end 24 is mounted on the outer periphery of the sleeve portion 202 and avoids the whole driver bit 1 sliding into the connected portion 203.

While an exchange or a replacement of the driver bit 1 is carried out, the user's thumb and forefinger can easily grip on the holder portions 21 to pull the driver bit 1 out of the driver handle 2. Because of the easy grip of the holder portions 21, user can favoringly force to overcome the magnetic attraction and the friction between the bit shank 11 and the connected portion 203 as to detach the driver bit 1 from the driver handle 2.

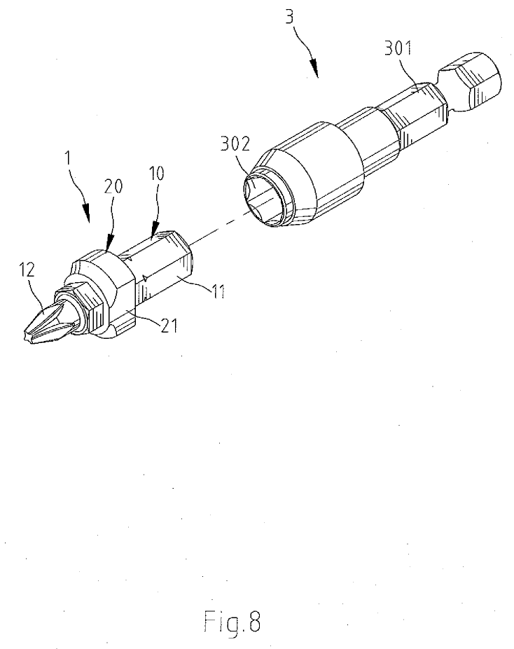

Referring to FIGS. 8, it shows a second embodiment in the present invention which is similar to the first embodiment except that the driver handle 2 is replaced by a connective rod 3. The connective rod 3 includes a handle portion 301 and a connected portion 302 formed on an end of the handle portion 301 for receiving the bit shank 11 of the driver bit 1. The connected portion 302 preferably has a magnetic material therein for connecting with the driver bit 1 magnetically. User's thumb and forefinger (not numbered) can grip the holder portion 21 of the bit flange 20 of the driver bit 1 to put the bit shank 11 of the driver bit 1 into the connected portion 302 of the connective rod 3. Accordingly, the driver bit 1 will not detach form the connective rod 3 freely because of the magnetic material of the connected portion 302. Simultaneously, the blocking end 24 is mounted on the outer periphery of the connected portion 302 and avoids the whole driver bit 1 sliding into the connected portion 302.

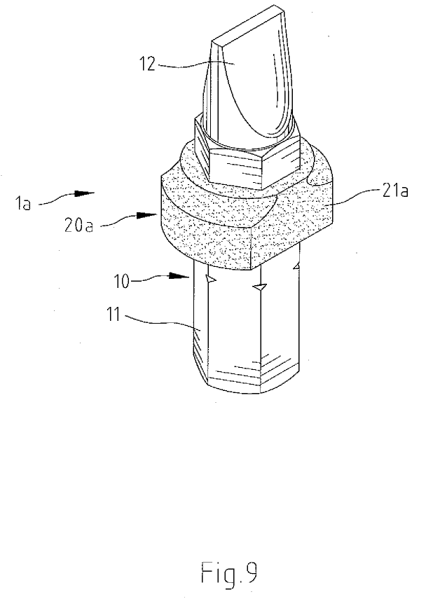

Referring to FIG. 9, it shows a driver bit 1 a in accordance with a third embodiment in the present invention. The driver bit 1 a is similar to the driver bit 1 in the first embodiment except that a bit flange 20a replaces the bit flange 20. Preferably the bit flange 20a is colored with a selection of random colors for indicating what type the driving end 12 is. However, the bit flange 20a is made of plastic and pre-buried within the body 10; the bit flange 20a is colored during inject-molding. The color of the bit flange 20a can not only indicate the type of the driving end 12, but also the size of the driving end 12.

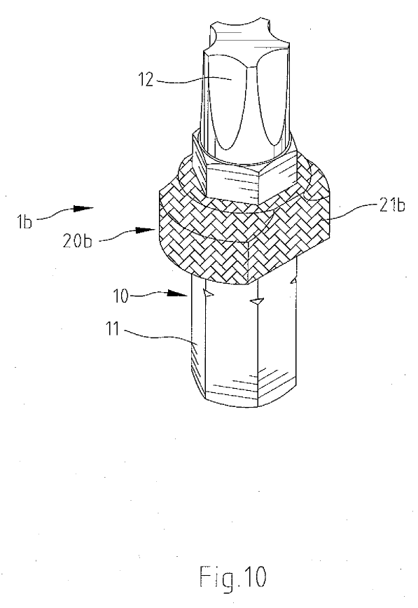

Referring to FIG. 10 it shows a driver bit 1b in accordance with a fourth embodiment in the present invention. The driver bit 1b is similar to the driver bit 1 in the first embodiment except that a bit flange 20b replaces the bit flange 20. Preferably the bit flange 20b is colored with a selection of random colors for indicating what type the driving end 12 is. However, when the bit flange 20b is integrally formed from the body 10 as one piece, the bit flange 20b is colored by paints or the like. The color of the bit flange 20b can not only indicate the type of the driving end 12, but also the size of the driving end 12.

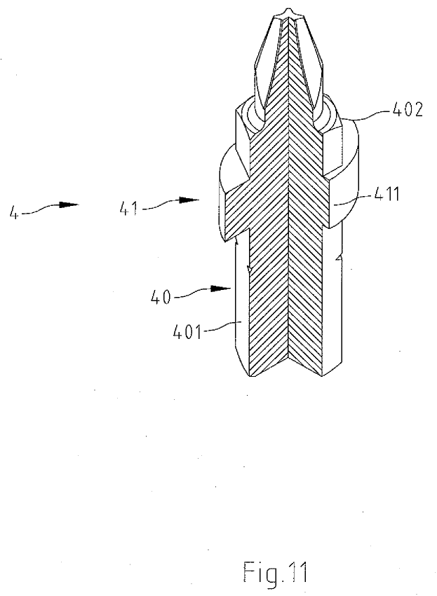

Referring to FIG. 11, it shows a driver bit 4 in accordance with a fifth embodiment in the present invention. The driver bit 4 includes a body 40 and a bit flange 41 integrally formed from the body 40 and located in position of the body 40. Hence, the material of the body 40 is equal to that of the bit flange. In addition, the body 40 includes a bit shank 401 formed on an end thereof and a driving end 402 formed on another end thereof opposite to the bit shank 401, with the bit flange 41 between the bit shank 401 and the driving end 402. The bit flange 41 is preferably arcuate and has two holder portions 411 formed on the outer periphery thereof and opposite to each other. Each of the holder portions 411 has smooth outer curvature for user to grip thereon easily. Moreover, the holder portions 411 can be a selection of various shapes as long as user's thumb and forefinger can grip on the holder portions 411 to force on the bit flange 41 easily.

1. (canceled)

2. The driver bit as claimed in claim 9, with each of the two holder portions having a flat surface thereon.

3. The driver bit as claimed in claim 9, further comprising a driver handle including a connected portion connecting with the bit shank.

4. The driver bit as claimed in claim 3, wherein the driver handle further comprises a handle portion and a sleeve portion extending from an end of the handle portion, with the connected portion defined on an end of the sleeve portion opposite to the handle portion.

5. The driver bit as claimed in claim 9, further comprising a connective rod including a handle portion and a connected portion formed on an end of the handle portion, with the connected portion connecting with the bit shank.

6. The driver bit as claimed in claim 4, wherein the bit flange further comprises a blocking end mounted on the outer periphery of the sleeve portion and avoids the bit flange combined with the body from sliding into the connected portion of the driver handle.

7. The driver bit as claimed in claim 5, wherein the bit flange further comprises a blocking end mounted on the outer periphery of the connected portion and avoids the bit flange combined with the body from sliding into the connected portion of the connective rod.

8. The driver bit as claimed in claim 9, with the bit flange being made of plastic and inject-molded via pre-buried with the body.

9. A driver bit for a driver tool, the driver bit comprising:
a body including a bit shank formed on an end thereof and a driving end formed on another end thereof opposite to the bit shank, with the driving end adapted for operation with a fastener wherein the body of the driver bit further comprises a groove defined thereon between the bit shank and the driving end, with the groove being spaced from and intermediate the end and the other end of the body;
a bit flange comprising an outer periphery, first and second ends and a through-hole extending between the first and second ends of the bit flange, with the through-hole having an inner wall;
a limited portion protruding from the inner wall of the through-hole spaced from and intermediate the first and second ends of the bit flange, with the limited portion exactly corresponding to the groove of the body; and
two holder portions formed on the outer periphery of the bit flange for a user's thumb and forefinger to grip thereon, with the two holder portions opposite to each other, wherein when the bit flange is combined with the body, the limited portion is received in the groove of the body.

10. The driver bit as claimed in claim 9, wherein the bit flange further comprises two further limited portions delimited around the through-hole and respectively open to the first and second ends of the bit flange and mounted on the body, with the body having a first abutting end and a second abutting end, with the groove defined between the first and second abutting ends, with the two further limited portions respectively corresponding to and mounted on the first and second abutting ends.

11. The driver bit as claimed in claim 10, with the two further limited portions being hexagonal, with the first and second abutting ends respectively being hexagonal so that the bit flange does not rotate relative to the body.

12. The driver bit as claimed in claim 9, with the bit flange colored with a selection of random various colors for indicating the type of the driving end.

13. The driver bit as claimed in claim 3, with the bit shank magnetically connected with the connected portion of the driver handle.

14. The driver bit as claimed in claim 5, with the bit shank magnetically connected with the connected portion of the connective rod.

15. The driver bit as claimed in claim 3, further comprising a plurality of notches provided on the bit shank adjacent to the groove, with the notches for attachment and detachment of the driver bit from the driver handle via a quick release device.

16. The driver bit as claimed in claim 5, further comprising a plurality of notches is provided on the bit shank adjacent to the groove, with the notches for attachment and detachment of the driver bit from the connective rod via a quick release device.

17. (canceled)
